(19) United States
(12) Patent Application Publication
(10) Pub. No.: US 2024/0028872 A1
(43) Pub. Date: Jan. 25, 2024

(54) ESTIMATION APPARATUS, LEARNING APPARATUS, METHODS AND PROGRAMS FOR THE SAME

(71) Applicant: NIPPON TELEGRAPH AND TELEPHONE CORPORATION, Tokyo (JP)

(72) Inventors: Shin MURATA, Tokyo (JP); Yuma KOIZUMI, Tokyo (JP); Noboru HARADA, Tokyo (JP)

(73) Assignee: NIPPON TELEGRAPH AND TELEPHONE CORPORATION, Tokyo (JP)

(21) Appl. No.: 17/425,684

(22) PCT Filed: Aug. 30, 2019
(86) PCT No.: PCT/JP2019/034216

§ 371 Date: Jul. 23, 2021

(30) Foreign Application Priority Data
Jan. 28, 2019 (JP) 2019-011981

(51) Int. Cl. G06N 3/0455

(52) U.S. Cl. CPC G06N 3/0455

(57) ABSTRACT

An estimation apparatus includes a state estimation unit that estimates a state from an observed amount using an encoder, an observed amount estimation unit that estimates an observed amount from a state using a decoder, and a future observed amount estimation unit that estimates a future observed amount, which is a value to which the observed amount changes with time, using a parameter K representing time evolution, where a parameter of the encoder, a parameter of the decoder, and the parameter K are optimized simultaneously.

### TECHNICAL FIELD

The present invention relates to an estimation apparatus that estimates a state from an observed amount using a state-space model and a learning apparatus, and relates to methods therefor and programs therefor.

### BACKGROUND ART

A framework called a state-space model is widely used to analyze the properties of objects from series data. A state-space model includes a hidden “state model” that is unobservable and an “observation model” that is a result of observation, and can be considered as a model in which an amount called a “state” evolves with time and series data of observed amounts (for example, “amounts” regarding current, sound pressure, an image, or the like) is generated from these states through an observation process.

A state changes non-linearly with time (evolves non-linearly with time) and an observed amount can be obtained by performing an observation process of changing non-linearly with time as the state changes with time (i.e., can be obtained through the observation process). It is difficult to learn the entirety of a state-space model from observed amounts alone without prior assumptions due to the non-linearity of the observation process and time evolution. On the other hand, a method called Koopman mode decomposition which has been studied in recent years can avoid the above non-linearity by considering the state-space model in another domain (a function space) (see Non Patent Literatures 1 and 2).

### CITATION LIST

### Non Patent Literature

Non Patent Literature 1: Matthew O. Williams. Clarence W. Rowley, and Ioannis G. Kevrekidis., “A Kernel-Based Approach to Data-Driven Koopman Spectral Analysis,” Journal of Computational Dynamic, 2:247-265, 2015. arXiv: 1411.2260.
Non Patent Literature 2: Matthew O. Williams, Ioannis G. Kevrekidis, and Clarence W. Rowley., “A Data-Driven Approximation of the Koopman Operator: Extending Dynamic Mode Decomposition,” Journal of Nonlinear Science, 25(6):1307-1346, 2015.

### SUMMARY OF THE INVENTION

### Technical Problem

However, when the state is unknown, all of the observation process, the time evolution, and the state still cannot be learned from observed amounts alone because the Koopman mode decomposition cannot be applied.

It is an object of the present invention to provide a learning apparatus that learns an observation process, a time evolution, and a state from an observed amount alone, an estimation apparatus that estimates a state from an observed amount using the observation process, the time evolution, and the state learned from the observed amount alone, methods for the learning and estimation apparatuses, and programs for the learning and estimation apparatuses.

### Means for Solving the Problem

To achieve the above object, one aspect of the present invention is to provide an estimation apparatus including a state estimation unit configured to estimate a state from an observed amount using an encoder, an observed amount estimation unit configured to estimate an observed amount from a state using a decoder, and a future observed amount estimation unit configured to estimate a future observed amount using a parameter K representing time evolution, the future observed amount being a value to which the observed amount changes with time, wherein a parameter of the encoder, a parameter of the decoder, and the parameter K are optimized simultaneously.

### Effects of the Invention

According to the present invention, the observation process, the time evolution, and the state can be learned from the observed amount alone. Another advantage is that a state can be estimated from an observed amount by using the observation process, the time evolution, and the state learned from the observed amount alone.

### BRIEF DESCRIPTION OF DRAWINGS

FIG. 1 is a diagram illustrating an outline of a first embodiment.

FIG. 2A is a diagram for explaining a spatial state model of the related art and FIG. 2B is a diagram for explaining a framework of an autoencoder of the first embodiment.

FIG. 3 is a diagram illustrating an exemplary configuration of an estimation system according to the first embodiment.

FIG. 4 is a functional block diagram of a learning apparatus according to the first embodiment.

FIG. 5 is a flowchart of an example of processing of the learning apparatus according to the first embodiment.

FIG. 6 is a diagram for explaining an algorithm at a learning stage.

FIG. 7 is a functional block diagram of an estimation apparatus according to the first embodiment.

FIG. 8 is a flowchart of an example of processing of the estimation apparatus according to the first embodiment.

FIG. 9 is a diagram for explaining an algorithm at an estimation stage.

FIG. 10 is a diagram illustrating an example in which series data was generated by actually learning parameters with series data of data based on image data taken as an input.

FIG. 11 is a diagram for explaining an algorithm for predicting an observed amount corresponding to a state.

FIG. 12 is a functional block diagram of an abnormality detection apparatus according to a second embodiment.

FIG. 13 is a flowchart of an example of preprocessing of the abnormality detection apparatus according to the second embodiment.

FIG. 14 is a flowchart of an example of an abnormality detection process of the abnormality detection apparatus according to the second embodiment.

FIG. 15 is a diagram illustrating an outline of a third embodiment.

FIG. 16 is a functional block diagram of a learning apparatus according to the third embodiment.

FIG. 17 is a functional block diagram of an estimation unit of an estimation apparatus according to the third embodiment.

FIG. 18 is a flowchart of an example of processing of the estimation unit of the estimation apparatus according to the third embodiment.

### DESCRIPTION OF EMBODIMENTS

Hereinafter, embodiments of the present invention will be described. In the drawings used in the following description, the same reference signs are given to components having the same function or the steps of performing the same processing, and duplicate description is omitted. In the following description, a symbol “\hat{ }” or the like used in the text is originally written directly above the character immediately after it, but is written immediately before the character due to a limitation of text notation. In the expressions, such symbols are written in their original positions. It is assumed that processing performed for each element of a vector or a matrix is applied to all elements of the vector or the matrix unless otherwise specified.

### Points of First Embodiment

In the present embodiment, not only a time evolution and an observation process but also the “inverse function” of the observation process are learned simultaneously, thereby making it possible to learn all of the observation process, a time evolution, and a state from an observed amount. Specifically, an autoencoder network is used (see Reference 1).
(Reference 1) G. E. Hinton. “Reducing the Dimensionality of Data with Neural Networks,” Science, 313(5786): 504-507, July 2006.

An autoencoder converts an input into a smaller number of dimensions using a network called an encoder and restores it using a network called a decoder. Here, the basic technique of the present embodiment involves regarding the encoder as the “inverse function” and the decoder as the observation process, thereby enabling simultaneous learning of the inverse function and the observation process. A state-space model includes an observation model that estimates an observed amount from a state that changes with elapse of time and is unobservable, and a state model that estimates a state that changes with elapse of time, as described above. That is, a state-space model is based on the premise that an observed amount is estimated from a state. However, such a model cannot be constructed if the state is unknown as described above. Thus, the framework of the autoencoder is used to learn the encoder as a model that estimates a state from an observed amount and the decoder as a model that estimates an observed amount from a state, thereby enabling construction of a model that estimates an observed amount from a state. Namely, this construction is to learn a model with the input and output reversed.

The basic technique of the present embodiment will be described below.

A state xₜ will be considered. Here, it does not matter whether the state is abstract or concrete. The state evolves with time as follows.

xₜ₊₁=f(xₜ) (1)

From this state xₜ, an observed amount yₜ is obtained through an observation process given by the following expression.

yₜ=g(xₜ) (2)

Here, the observed amount is that quantified using some method (such as, for example, a current/voltage, a temperature, a sound pressure, or an image) and may be multidimensional data such as that obtained by a microphone array.

The goal of the framework of the state-space model is to determine the following when series data {y₁, . . . , y_{T}} of observed amounts has been obtained.
Series data of states {x₁, . . . , x_{T}}
Time evolution function f(xₜ)
Observation process function g(xₜ)

However, it is generally difficult to determine the entirety of the state-space model from observed amounts alone. This is partly because the time evolution f(xₜ) and the observation process g(xₜ) are generally non-linear and it is difficult to determine them without prior knowledge.

Koopman mode decomposition is a technique that can avoid the above non-linearity.

Koopman Mode Decomposition

### Basis Function

Ψ(x)≡[ψ₁(x), . . . ,ψ_{τ}(x), . . . ] [Math. 1]

The observation process function is expanded as follows using a basis function given above.

$$[ Math . 2 ]$$

$$g ( {x}_{t} ) = {\sum }_{r = 1}^{∞} {b}_{r} {ψ}_{r} ( {x}_{t} ) = B Ψ ( {x}_{t} ) \qquad ( 3 )$$

Here, using the idea of the Koopman operator, the time evolution of the basis function can be rewritten as follows.

Ψ(x_{T+1})=Ψ(f(x_{T}))=KΨ(x_{T}) (4)

In summary, by describing in an (infinite dimensional) function space with an appropriate transformation zₜ=Ψ(xₜ), an original state-space model can be rewritten as a linear state-space model.

The above original state-space model is given by the following expression.

$$[ Math . 3 ]$$

$$\{ \begin{matrix}{x}_{t + 1} = f ( {x}_{t} ) \\ {y}_{t} = g ( {x}_{t} )\end{matrix} \qquad ( 5 )$$

The above linear state-space model is given by the following expression.

$$[ Math . 4 ]$$

$$\{ \begin{matrix}{z}_{t + 1} = {Kz}_{t} \\ {y}_{t} = {Bz}_{t}\end{matrix} \qquad ( 6 )$$

As mentioned above, it is difficult to learn a generative model without prior information because of the non-linearity of the time evolution and the observation process in the state-space model. On the other hand, Koopman mode decomposition can avoid the non-linearity by describing the state-space model in the function space. However, Koopman mode decomposition is applicable when the state xₜ is known. Thus, even if Koopman mode decomposition is used, it is difficult to learn the time evolution, the observation process, and the state from the series data of observed amounts alone.

Therefore, the present embodiment devises a new state estimation method based on the framework of Koopman mode decomposition. Use of the present embodiment enables learning of all of the time evolution, the observation process, and the state simultaneously from the series data of observed amounts alone.

Basic Idea

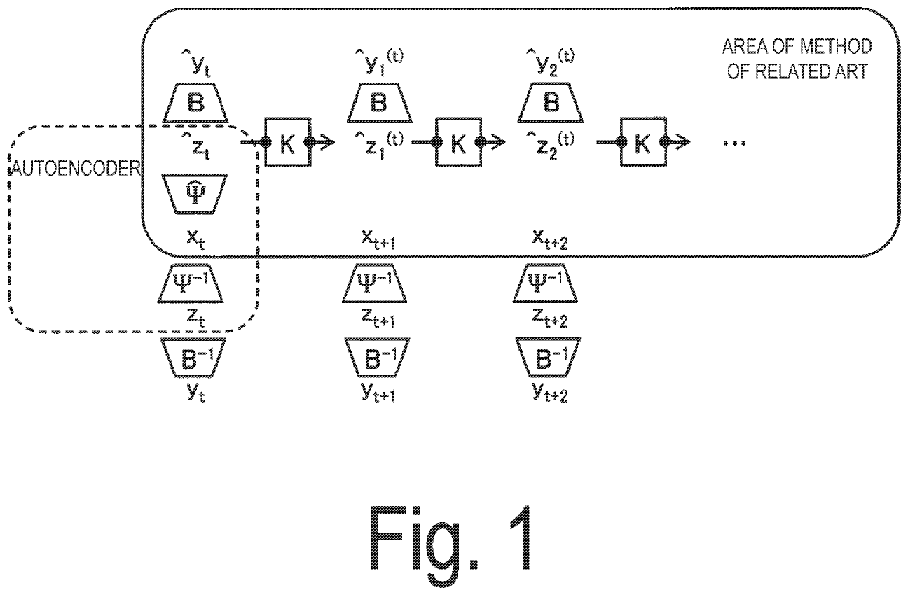

FIG. 1 illustrates an outline of the present embodiment. A state xₜ, an observation process (\hat{ }Ψ, B), and a time evolution K are learned taking series data {yₜ} of observed amounts as an input. After learning, the state xₜ and series data \hat{ }y₁^{(t)}, \hat{ }y₂^{(t)}, . . . of observed amounts predicted from a certain observed amount yₜ are output.

An observed amount \hat{ }yₜ is generated from the state xₜ as follows.

$$[ Math . 5 ]$$

$$\{ \begin{matrix}\hat{{z}_{t}} = Ψ ( {x}_{t} ) \\ {\hat{y}}_{t} = B \hat{{z}_{t}}\end{matrix} \qquad ( 7 )$$

Therefore, to estimate the state xₜ from the current observed amount yₜ, it is necessary to solve the inverse problem of the above. The inverse problem is given by the following expression.

$$[ Math . 6 ]$$

$$\{ \begin{matrix}{z}_{t} = {B}^{- 1} ( {y}_{t} ) \\ {x}_{t} = {Ψ}^{- 1} ( {z}_{t} )\end{matrix} \qquad ( 8 )$$

B⁻¹ (•) can be obtained analytically by a pseudo inverse matrix of B or ridge regression. On the other hand, it is generally difficult to obtain the inverse function Ψ⁻¹(•) of the basis function Ψ(•). Here, an implementation example of determining the inverse function, the basis function, and the state using the framework of an autoencoder network will be described. An autoencoder network is a neural network used to reduce the number of dimensions of data, where an input is transferred to a middle layer through an encoder and restored through a decoder. This is expressed as follows.

$$[ Math . 7 ]$$

$$\{ \begin{matrix}x = {Φ}^{- 1} ( z ; {w}_{ent} ) \\ z = Φ ( x ; {w}_{dec} )\end{matrix} \qquad ( 9 )$$

Here, the encoder Φ⁻¹ is regarded as the inverse function Ψ⁻¹(•) of the basis function and the decoder Φ is regarded as the basis function Ψ(•).

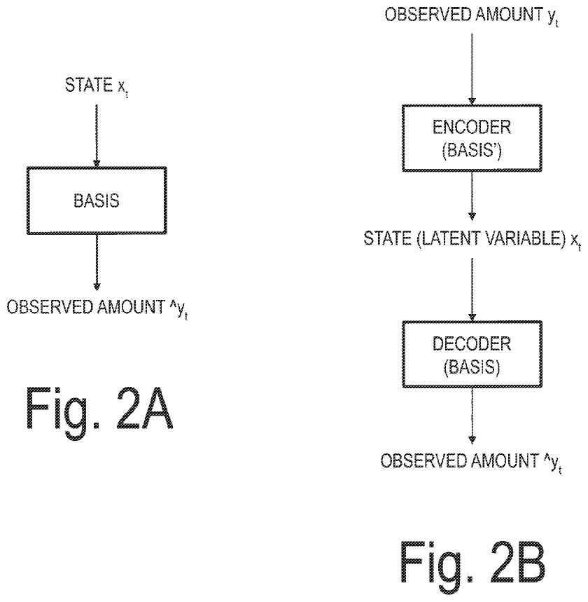

In other words, in the related art, a basis which enables linear transformation with elapse of time is obtained to obtain a spatial state model in which a state xₜ is converted into \hat{ }zₜ using the basis and a predicted observed amount \hat{ }yₜ is derived from \hat{ }zₜ and a coefficient B (see FIGS. 1 and 2A). On the other hand, in the present embodiment, learning is performed using the framework of an autoencoder including an encoder which takes an observed amount yₜ as an input and outputs a state xₜ and a decoder which takes the state xₜ as an input and outputs an observed amount \hat{ }yₜ (See FIGS. 1 and 2B).

### First Embodiment

The present embodiment is divided into two stages. One is a stage of learning a time evolution, an observation process, and an inverse function thereof from time series data of observed amounts (hereinafter also referred to as a learning stage). The other is a stage of acquiring a state from an observed amount (hereinafter also referred to as a state acquisition stage).

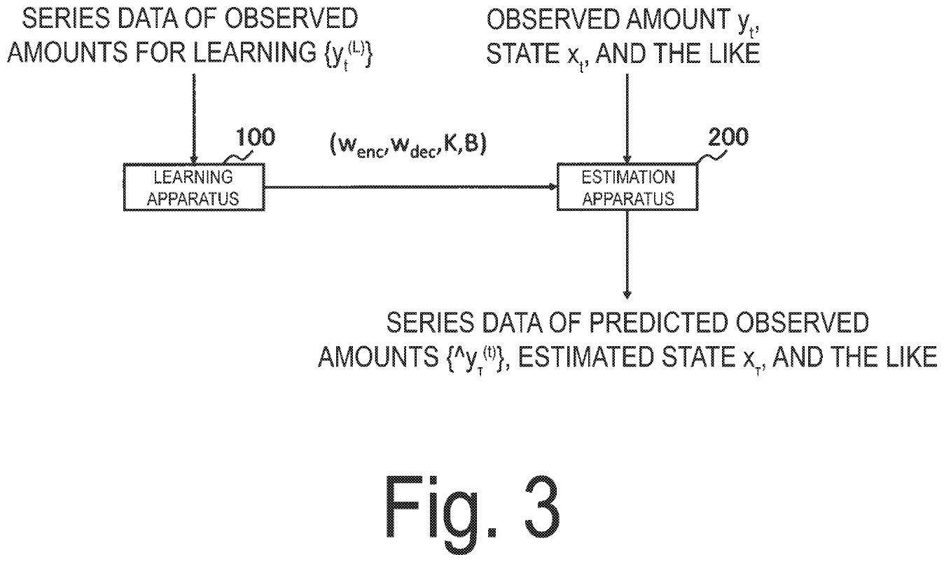

A state acquisition system according to the present embodiment includes a learning apparatus 100 and a state acquisition apparatus 200 (see FIG. 3). The state acquisition apparatus 200 is also referred to as an estimation apparatus 200 because it estimates a state from an observed amount or an observed amount from a state. Similarly, the state acquisition stage is also referred to as an estimation stage and the state acquisition system is also referred to as an estimation system.

The learning apparatus 100 executes the learning stage and the estimation apparatus 200 executes the estimation stage. First, the learning stage will be described.

Learning Stage

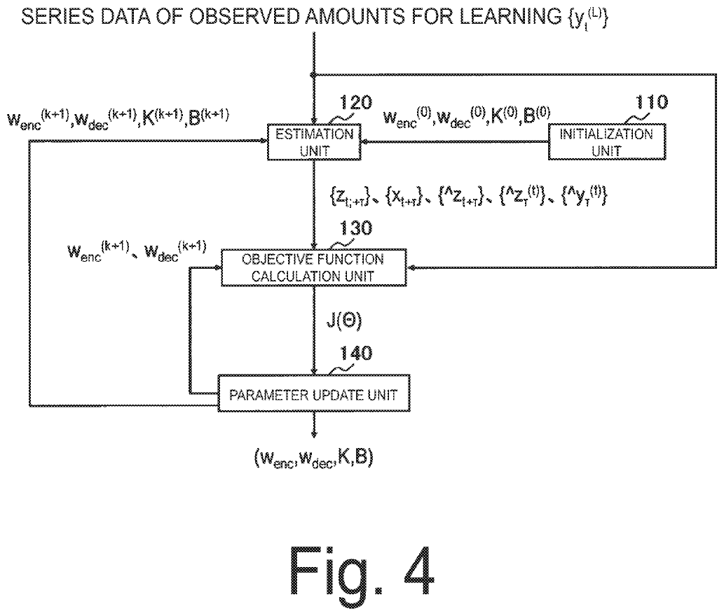

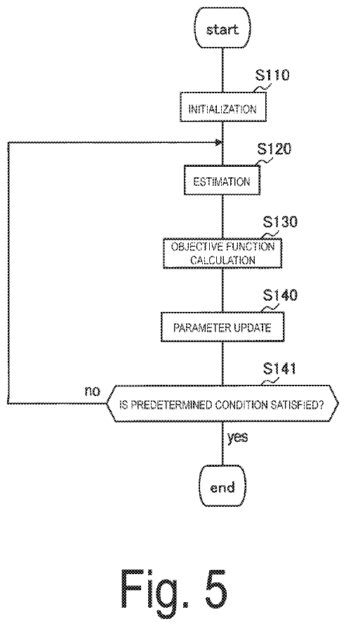

FIG. 4 illustrates a functional block diagram of the learning apparatus 100 and FIG. 5 illustrates a flowchart of an example of its processing. The learning apparatus 100 includes an initialization unit 110, an estimation unit 120, an objective function calculation unit 130, and a parameter update unit 140.

The learning apparatus 100 takes series data {yₜ^{(L)}} of observed amounts for learning as an input and outputs parameters (w_{enc}, w_{dec}, K, B) which are learning results. w_{enc} represents a parameter used in the encoder (a parameter of the inverse function Ψ⁻¹), w_{dec} represents a parameter used in the decoder (a parameter of the basis function Ψ), K represents a parameter representing the time evolution, and B represents the expansion coefficient.

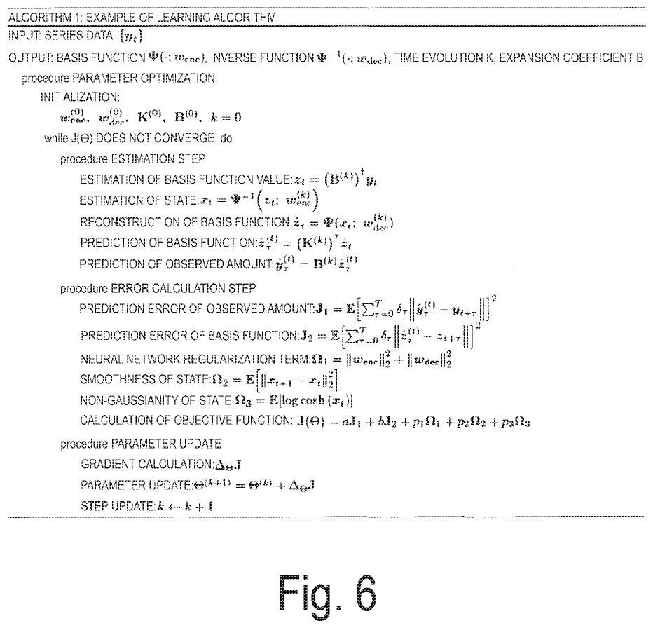

The learning stage is performed as in algorithm 1 of FIG. 6. This illustrates an example in which an observed amount for learning is data based on image data. Here, series data {yₜ}(e.g. moving image data) including pieces of data based on image data will be considered as input data. The data yₜ based on the image data may be, for example, data including pixel values of pixels and having a number of dimensions corresponding to the number of the pixels or may be a feature obtained from the image data, a feature obtained from the moving image data, or the like. When the data based on image data is taken as input data, the state represents an abstract state corresponding to the observed amount yₜ and the abstract state may have a value with a physical meaning (for example, a value with a smaller number of dimensions than the observed amount). For example, the state represents an amount similar to the size or position of a periodic pattern or object appearing in image data or an amount similar to the phase of a moving body in moving image data including pieces of image data (wfhen the movement is periodic).

Initialization Unit 110

Prior to learning, the initialization unit 110 initializes the parameters w_{enc}^{(k)}, w_{dec}^{(k)}, K^{(k)}, and B^{(k)} used for inference (S110) and outputs the initialized parameters w_{enc}⁽⁰⁾, w_{dec}⁽⁰⁾, K⁽⁰⁾, B⁽⁰⁾ to the estimation unit 120. Further, an index k indicating the number of updates is set such that k=0.

Estimation Unit 120

The estimation unit 120 takes the series data {yₜ^{(L)}} of observed amounts for learning and the initialized or updated parameters w_{enc}^{(k)}, w_{dec}^{(k)}, K^{(k)}, and B^{(k)} as inputs to perform (1) estimation of a basis function value (to obtain an estimated value zₜ), (2) estimation of a state (to obtain an estimated value xₜ), (3) estimation of a reconstructed basis function value (to obtain an estimated value \hat{ }zₜ), (4) prediction of a basis function (to obtain a predicted value \hat{ }z_{τ}^{(t)}), and (5) prediction of an observed amount (to obtain a predicted value \hat{ }y_{τ}^{(t)})(S120) and outputs the estimated values zₜ, xₜ, and \hat{ }zₜ and the predicted values \hat{ }z_{τ}^{(t)} and \hat{ }y_{τ}^{(t)}). Hereinafter, estimation and prediction are collectively referred to as estimation. Details of the estimation will be described below.

(1) First, the estimation unit 120 estimates the basis function value zₜ using the current expansion coefficient B^{(k)}. That is, zₜ=B^{(k)+}(yₜ^{(L)}). Here, B^{(k)+}(•) represents solving the regression problem. In the present embodiment, B^{(k)+}(•)=(B^{(k)T}B^{(k)}+σ1)⁻¹B^{(k)T} is used for the problem of ridge regression, but general linear regression using a pseudo inverse matrix or a sparse estimation algorithm such as LASSO may also be used. Here, σ is a predetermined weight parameter in the ridge regression.

(2) Next, the estimation unit 120 estimates the state such that xₜ=Φ⁻¹(zₜ; w_{enc}^{(k)}) using the neural network of Expression (9).

(3) Further, the estimation unit 120 estimates a reconstructed basis function value such that \hat{ }zₜ=Φ(xₜ; w_{dec}^{(k)} using the neural network of Expression (9).

(4) Next, the estimation unit 120 performs linear prediction of a basis function value for τ=0, . . . , T to obtain a predicted value of the basis function value such that \hat{ }z_{τ}^{(t)}=K^{(k)τ}\hat{ }zₜ.

(5) Based on the predicted value \hat{ }z_{τ}^{(t)}, the estimation unit 120 obtains a predicted value of the observed amount such that \hat{ }y_{τ}^{(t)}=B^{(k)}\hat{ }z_{τ}^{(t)}.

Objective Function Calculation Unit 130

The objective function calculation unit 130 takes the series data {y_{t+τ}^{(L)}} of observed amounts for learning, the series data of estimated values {z_{t+τ}}, {x_{t+τ}}, and {\hat{ }z_{t+τ}}, the series data of predicted values {z_{τ}^{(t)}}, {\hat{ }yτ^{(t)}}, and the parameters w_{enc}^{(k)} and w_{dec}^{(k)} as inputs to calculate a value of the objective function J(Θ) (S130) and outputs the calculated value J(Θ). Here. Θ is a set of parameters w_{enc}^{(k)}, w_{dec}^{(k)}, K^{(k)}, and B^{(k)}.

(i) First, the objective function calculation unit 130 obtains a prediction error of the observed amount using the following expression.

l₁=E[Σ_{τ=0}^{T}δ_{τ}∥ŷ_{τ}^{(t)}−y_{t+τ}^{(t)}∥]² [Math. 8]

Here, δ_{τ} satisfies 0<δ^{τ}<1, which is a weight parameter for setting the error such that it is estimated as being higher as the corresponding time t+τ becomes closer to the current time t, and E[•] represents expected value calculation.

(ii) The objective function calculation unit 130 also obtains a prediction error of the basis function using the following expression.

l₂=E[Σ_{τ=0}^{T}δ_{τ}∥\hat{z}_{τ}^{(t)}−z_{t+τ}∥]² [Math. 9]

(iii) A regularization term Ω1 for the weights of the neural network is further introduced as a regularization term. Here, Ω₁=∥w_{enc}^{(k)}∥2²+∥w_{dec}^{(k)}∥2².

(iv) Structures of the state are also introduced. In the present embodiment, smoothness Ω₂=E[∥xₜ₊₁−xₜ∥2²] and non-Gaussianity Ω₃=E[log cosh(xₜ)] are introduced. Here, cosh(•) represents a hyperbolic function.

(v) The objective function calculation unit 130 obtains the value of the objective function J(Θ)=aJ₁+bJ₂+p₁Ω₁+p₂Ω₂+p₃Ω₃ with the above terms weighted. Here, a, b, p₁, p₂, and p₃ are parameters for determining how much importance is placed on J₁, J₂, Ω₁, Ω₂, and Ω3, respectively, and are appropriately set using experimental results and simulation results.

Parameter Update Unit 140

The parameter update unit 140 receives the objective function J(Θ) and updates each parameter w_{enc}^{(k)}, w_{dec}^{(k)}, K^{(k)}, and B^{(k)} (S140). For example, using back propagation, the parameter update unit 140 calculates the gradient ΔΘJ with respect to each parameter and updates each parameter w_{enc}^{(k)}, w_{dec}^{(k)}, K^{(k)}, and B^{(k)} (Θ^{k+1)}=Θ^{(k)}+Δ_{Θ}J).

If a predetermined condition (for example, a predetermined number of loops have ended or the objective function does not change) is not satisfied (no in S141), the parameter update unit 140 outputs the updated parameters w_{enc}^{(k+1)}, w_{dec}^{(k+1)}, K^{(k+1)}, and B^{(k+1)} to the estimation unit 120, outputs the updated parameters w_{enc}^{(k+1)} and w_{dec}^{(k+1)} for calculating the regularization term Ω₁ to the objective function calculation unit 130, sets k such that k←k+1, and repeats S120 to S140.

If the predetermined condition is satisfied (yes in S141), the parameter update unit 140 stops the parameter update and completes learning the model. The parameter update unit 140 outputs the latest parameters w_{enc}^{(k)}, w_{dec}^{(k)}, K^{(k)}, and B^{(k)} to the estimation apparatus 200 as parameters (w_{enc}, w_{dec}, K, B) that are learning results.

Estimation Stage

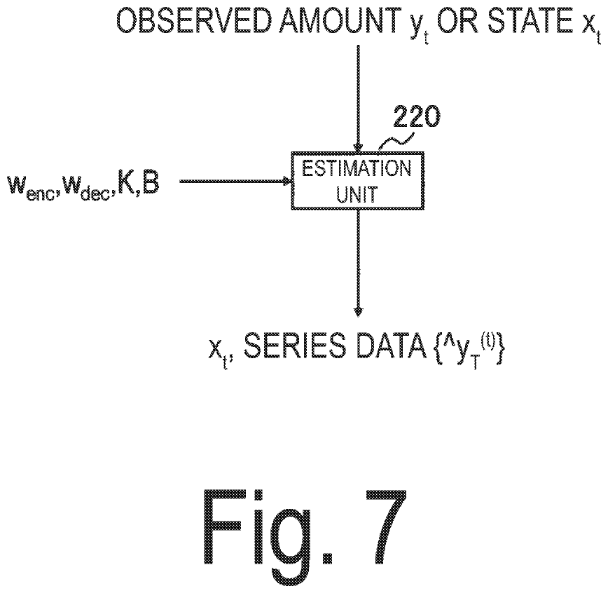

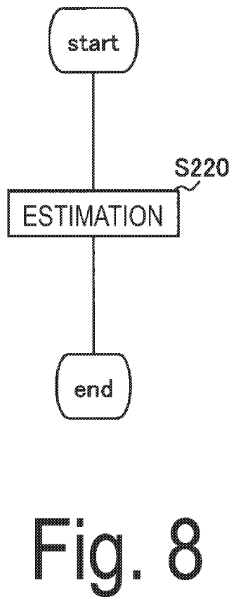

FIG. 7 illustrates a functional block diagram of the estimation apparatus 200 and FIG. 8 is a flowchart of an example of its processing. The estimation apparatus 200 includes an estimation unit 220.

The estimation apparatus 200 sets the parameters (w_{enc}, w_{dec}, K, B) received from the learning apparatus 100 in the estimation unit 220 prior to the estimation and prediction.

Algorithm 2

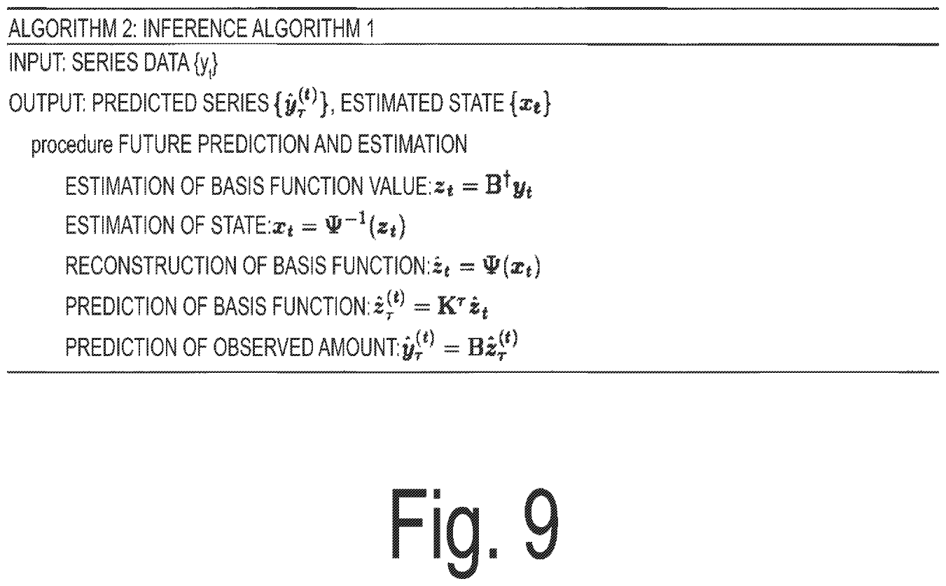

When algorithm 2 of FIG. 9 is executed, the estimation apparatus 200 takes an observed amount yₜ as an input, estimates a state corresponding to the observed amount yₜ, predicts series data of observed amounts subsequent to yₜ, and outputs the estimated value xₜ and the predicted series data {\hat{ }y_{τ}^{(t)}}. With the algorithm 2 of FIG. 9, data based on appropriate image data is given to the estimation unit 220 as an observed amount yₜ and image data of up to T steps ahead can be predicted. For example, the estimation apparatus 200 may take series data yₜ, yₜ₊₁, . . . , and y_{t+N} of observed amounts as an input and output series data xₜ, xₜ₊₁, . . . , x_{t+N} of estimated values and N pieces of predicted series data {\hat{ }y_{τ}^{(t)}}, {\hat{ }y_{τ}^{(t+1)}}, . . . , {\hat{ }y_{τ}^{(t+N)}}.

Estimation Unit 220

The estimation unit 220 takes an observed amount yₜ as an input and performs predetermined processes on the observed amount yₜ to estimate a state (S220). In the present embodiment, the predetermined processes are (1) estimation of a basis function value (to obtain an estimated value zₜ) and (2) estimation of a state (to obtain an estimated value xₜ). Further, the estimation unit 220 performs (3) estimation of a reconstructed basis function value (to obtain an estimated value \hat{ }zₜ), (4) prediction of a basis function (to obtain a predicted value \hat{ }z_{τ}^{(t)}), and (5) prediction of observed amounts (to obtain predicted values \hat{ }y_{τ}^{(t)}) (S220), and outputs the estimated value xₜ and series data of predicted values {\hat{ }y_{τ}^{(t)}}.

(1) First, the estimation unit 220 estimates a basis function value zₜ using the expansion coefficient B. That is, zₜ=B⁺(yₜ).

(2) Next, the estimation unit 220 estimates a state such that xₜ=Φ⁻¹(zₜ; w_{enc}) using the neural network of Expression (9).

(3) Further, the estimation unit 220 estimates a reconstructed basis function value such that \hat{ }zₜ=Φ(xₜ; w_{dec}) using the neural network of Expression (9).

(4) Next, the estimation unit 220 performs linear prediction of a basis function value for τ=0, . . . , T to obtain a predicted value of the basis function value such that \hat{ }z_{τ}^{(t)}=K^{τ}\hat{ }zₜ.

(5) Based on the predicted value \hat{ }z_{τ}^{(t)}, the estimation unit 220 obtains a predicted value of the observed amount such that \hat{ }y_{τ(t)}=B\hat{ }z_{τ}^{(t)}.

The above processes (3) to (5) are processes for obtaining the observed amount from the state and can be said to be the reverse of the above processes (1) and (2).

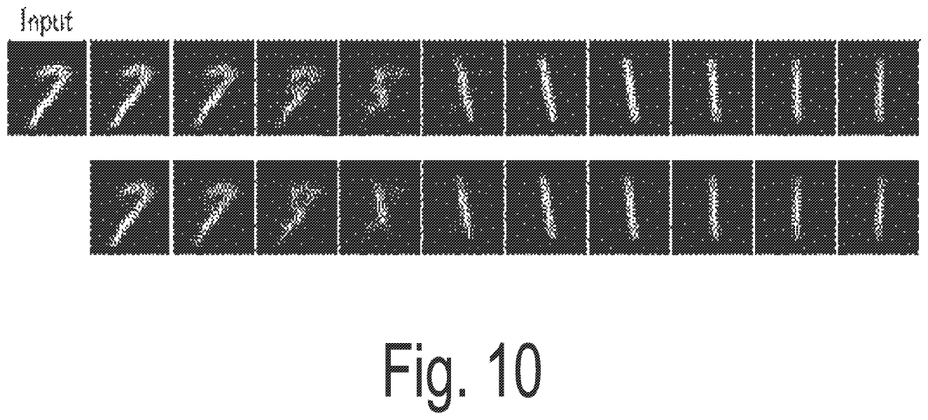

FIG. 10 illustrates an example in which series data was generated by actually learning parameters with series data of data based on image data taken as an input.

The upper row of FIG. 10 is series data of data based on actual image data (series data of observed amounts for learning). On the other hand, the lower row is series data (predicted series data) generated for τ=1, . . . , 10 with image data given as “Input” at the left end of the upper row input as yₜ of the algorithm 2.

Algorithm 3

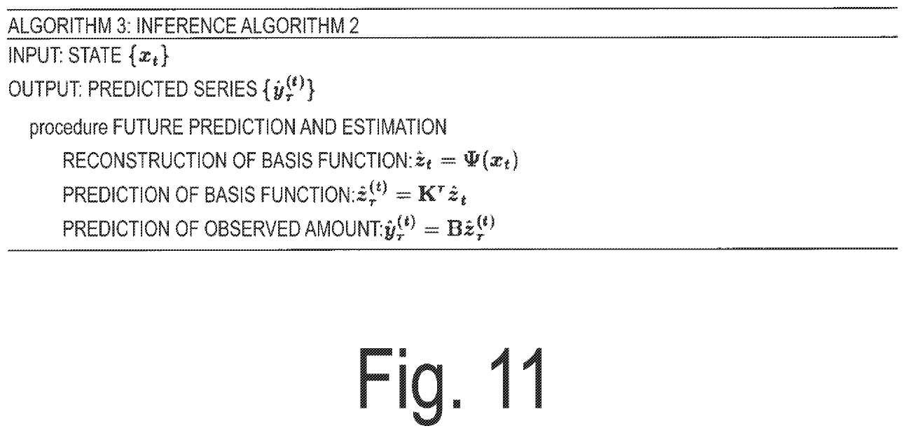

When algorithm 3 of FIG. 11 is executed, the estimation apparatus 200 takes a state xₜ as an input to predict an observed amount corresponding to the state xₜ and outputs predicted series data {\hat{ }y_{τ}^{(t)}}. With the algorithm 3 of FIG. 11, an appropriate state xₜ is given to the estimation unit 220 and images of up to T steps ahead can be predicted.

The estimation unit 220 takes a certain state xₜ as an input and performs (1) estimation of a reconstructed basis function value (to obtain an estimated value \hat{ }zₜ), (2) prediction of a basis function (to obtain a predicted value \hat{ }z_{τ}^{(t)}, and (3) prediction of observed amounts (to obtain predicted values \hat{ }y_{τ}^{(t)}) (S220), and outputs series data of predicted values {\hat{ }y_{τ}^{(t)}}.

(1) The estimation unit 220 estimates a reconstructed basis function value such that \hat{ }zₜ=Φ(xₜ; w_{dec}) using the neural network of Expression (9).

(2) Next, the estimation unit 220 performs linear prediction of a basis function value for τ=0, . . . , T to obtain a predicted value of the basis function value such that \hat{ }z_{τ}^{(t)}=K^{t}\hat{ }zₜ.

(3) Based on the predicted value \hat{ }z_{τ}^{(t)}, the estimation unit 220 obtains a predicted value of the observed amount such that \hat{ }y_{τ}^{(t)}=B\hat{ }z_{τ}^{(t)}.

Advantages

At the learning stage, the observation process, the time evolution, and the state can be learned from the observed amount alone.

At the estimation stage, the state can be estimated from the observed amount by using the observation process, the time evolution, and the state (the learned model) that have been learned from the observed amount alone. In addition, an observed amount can be predicted from an estimated state or a given state. That is, series data can be predicted by estimating a state from a current observed amount, simulating the time evolution, and observing the state. An observed amount or a state is also given, thereby data (a state or an observed amount) can be artificially generated.

A state can be estimated from series data observed by a sensor or the like and can be used for analysis of an observed amount. In addition, a state (for example, with a small number of dimensions) can be estimated from series data that is difficult to visually identify (for example, with a large number of dimensions) and the estimated state is presented, so that the observed amount can be converted (visualized) into one that is easy to visually identify.

Further, a distance between a predicted value and an actually observed amount can be appropriately defined and can be applied to abnormality detection of series data.

Modifications

Although the present embodiment has been described with respect to the case where the observed amount is data based on image data, other data may also be used. For example, data based on acoustic data, data based on vibration data, or a combination of data based on acoustic data and data based on vibration data can be considered. This will be described in more detail below.

Acoustic Data

When the observed amount is data based on acoustic data, sound pressure waveform data acquired from a microphone or its feature (such as STFT or log-Mel power) is taken as an input yₜ. When sound is collected with a microphone array, a vector obtained by combining a number of pieces of sound pressure waveform data or its feature corresponding to the number of elements of the microphone array is taken as the input yₜ.

In this case, the state represents an abstract state corresponding to the observed amount yₜ and the abstract state may have a value with a physical meaning (for example, a value with a smaller number of dimensions than the observed amount). For example, the state represents an amount of the waveform of a sound source, or the like, an amount of the position of the sound source, or the like (when the sound source moves), or an amount of the phase (when the sound is periodic), or the like.

Vibration Data

When the observed amount is data based on vibration data, acceleration waveform data acquired from a vibration pickup or its feature (such as STFT or log-Mel power) is taken as an input yₜ. When vibration data is collected with a plurality of vibration pickups, a vector obtained by combining a number of pieces of waveform data or its feature corresponding to the number of the vibration pickups is taken as the input.

In this case, the state represents an abstract state corresponding to the observed amount yₜ and the abstract state may have a value with a physical meaning (for example, a value with a smaller number of dimensions than the observed amount). For example, the state represents an amount of the mode of vibration, or the like, or an amount of the phase, or the like (when the vibration is that of a quasi-periodically moving object).

Acoustic/Vibration Data

When the observed amount is a combination of the data based on acoustic data and the data based on vibration data described above, a vector obtained by combining a number of pieces of acceleration waveform data acquired from vibration pickups or its features corresponding to the number of the vibration pickups and a number of pieces of sound pressure waveform data acquired from microphones or its features corresponding to the number of the microphones is taken as the input yₜ.

In this case, the state xₜ represents an abstract state corresponding to the observed amount yₜ and the abstract state may have a value with a physical meaning (for example, a value with a smaller number of dimensions than the observed amount). For example, the state represents an amount of the waveform of a sound source (a vibration source), or the like, or an amount of the mode of vibration, or the like.

### Second Embodiment

Parts different from the first embodiment will be mainly described.

In the present embodiment, the present invention is applied to abnormality detection.

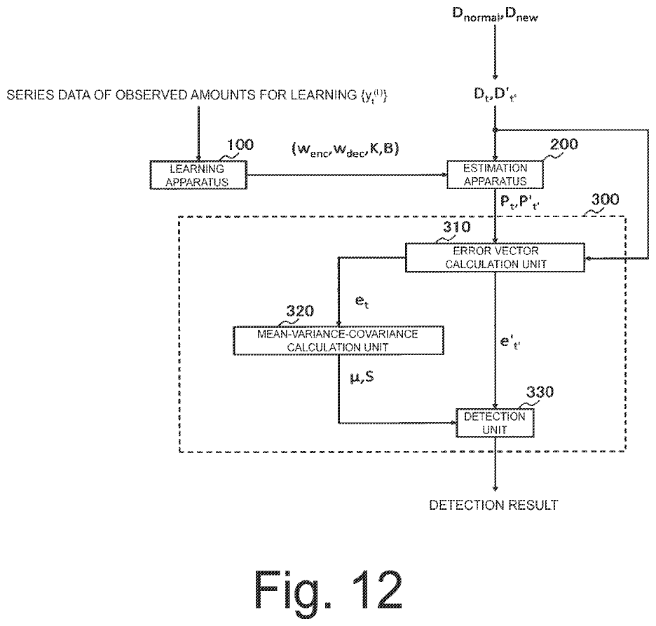

FIG. 12 illustrates a functional block diagram of an abnormality detection apparatus according to the present embodiment.

First, according to the method described in the first embodiment, the learning apparatus 100 takes series data {yₜ^{(L)}} of observed amounts for learning as an input, learns parameters (w_{enc}, w_{dec}, K, B), and outputs the learned parameters.

According to the method described in the first embodiment, the estimation apparatus 200 sets the parameters (w_{enc}, w_{dec}, K, B) received from the learning apparatus 100 in the estimation unit 220 prior to the estimation and prediction.

Abnormality Detection apparatus 300

The abnormality detection apparatus 300 includes an error vector calculation unit 310, a mean-variance-covariance matrix calculation unit 320, and a detection unit 330 (see FIG. 12).

The abnormality detection apparatus 300 performs an abnormality detection process and preprocessing for obtaining parameters in advance before the abnormality detection process. First, the preprocessing will be described.

Preprocessing

First, a dataset Dₙₒᵣₘₐₗ={y₁, v₂, . . . , y_{T_1}} for normal observed amounts is prepared. Here, the subscript A_B means A_{B}. From this dataset Dₙₒᵣₙₘₗ, sub-series of length L, Dₜ={yₜ₊₁, . . . , y_{t+L}} for t=1, 2, . . . , T₁-L are extracted.

Next, according to the method described in the first embodiment, the estimation apparatus 200 takes each observed amount yₜ as an input, predicts series data of observed amounts subsequent to yₜ, and outputs the predicted series data of length L, Pt={\hat{ }y^{(t)}₁, . . . , \hat{ }y^{(t)}_{L}}.

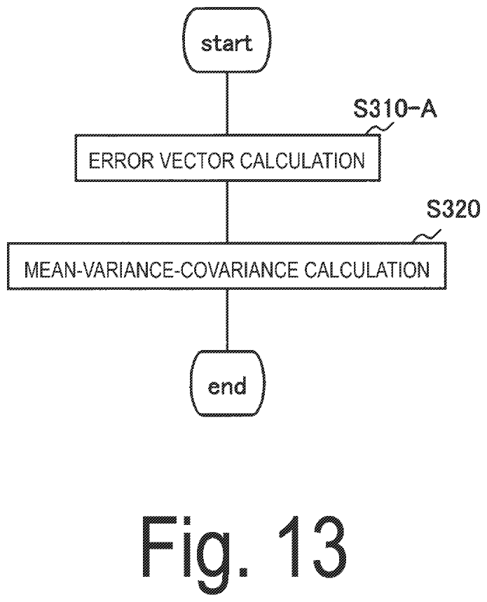

FIG. 13 is a flow chart of an example of the preprocessing.

Prior to the abnormality detection process, the abnormality detection apparatus 300 takes the T₁-L sub-series Dₜ obtained from the dataset Dₙₒᵣₘₐₗ of the normal observed amounts and the T₁-L pieces of predicted series data Pₜ as inputs and calculates a mean y and a variance-covariance matrix S which will be described later.

The error vector calculation unit 310 takes the T₁-L sub-series Dₜ={yₜ₊₁, . . . , y_{t+L}} and the T₁-L pieces of series data Pₜ={\hat{ }y^{(t)}₁, . . . , \hat{ }y^{(t)}_{L}} as inputs, calculates errors between elements of the sub-series Dₜ={yₜ₊₁, . . . , y_{t+L}} and elements of the predicted series data Pₜ={\hat{ }y^{(t)}, . . . , \hat{ }y^{(t)}_{L}} (S310-A), and outputs an error vector et=[e^{(t)}₁ . . . e^{(t)}_{L}]^{T}. Here, e^{(t)}ᵢ=yₜ₊₁−\hat{ }y^{(t)}ᵢ where i=1, . . . , L. An error vector when the observed amounts yₜ have been input (when the series data Pₜ={\hat{ }y^{(t)}₁, . . . , \hat{ }y^{(t)}_{L}} predicted from the observed amounts yₜ and the sub-series Dₜ={yₜ₊₁, . . . , y_{t+L}} corresponding to the series data Pₜ have been taken as inputs in this case) is defined such that eₜ=[e^{(t)}₁ . . . e^{(t)}_{L}]^{T}. This error vector eₜ is a vector having a length of (D×L) when the number of dimensions of each observed amount yₜ is D. The error vector calculation unit 310 performs this error vector calculation for all the T₁-L sub-series Dₜ and T₁-L pieces of series data Pₜ.

The mean-variance-covariance matrix calculation unit 320 takes the T₁-L error vectors eₜ=[e^{(t)}₁ . . . e^{(t)}_{L}]^{T} as inputs, calculates a mean μ and a variance-covariance matrix S using the following expression (S320), and outputs the calculated mean p and variance-covariance matrix S to the detection unit 330.

$$[ Math . 10 ]$$

$$μ = \frac{1}{{T}_{1} - 1} {\sum }_{t = 1}^{{T}_{1} - 1} {e}_{t}$$

$$[ Math . 11 ]$$

$$S = \frac{1}{{T}_{1} - 1} {\sum }_{t = 1}^{{T}_{1} - 1} ( {e}_{t} - μ ) {( {e}_{t} - μ )}^{T}$$

Abnormality Detection Process

When a dataset D_{new}={y′₁, y′₂, . . . , y_{T_2}} of observed amounts to be detected for abnormality has been obtained, sub-series of length L, D′ₜ={y_{t′+1}, . . . , y_{t′+L}} for t′=1, 2, . . . , T₂-L, are extracted similar to the preprocessing.

Next, according to the method described in the first embodiment, the estimation apparatus 200 takes each observed amount y′_{t′} as an input, predicts series data of observed amounts subsequent to y′_{t′}, and outputs the predicted series data of length L P′_{t′}={\hat{ }y′^{(t′)}, . . . , \hat{ }y′^{(t′)}_{L}}.

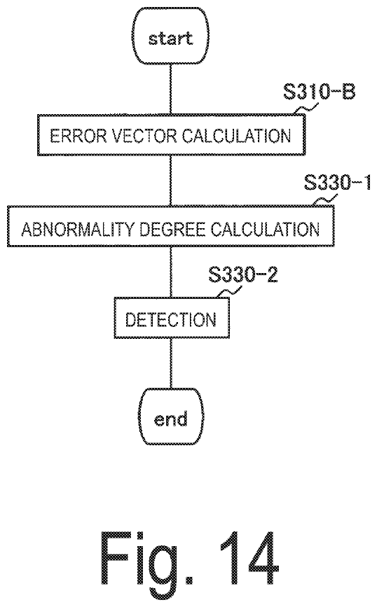

FIG. 14 is a flowchart of an example of the abnormality detection process.

During the abnormality detection process, the abnormality detection apparatus 300 takes the T₂-L sub-series D′ₜ obtained from the dataset D_{new} of observed amounts to be detected for abnormality and the T₂-L pieces of predicted series data P′ₜ={\hat{ }y′^{(t′)}₁, . . . , \hat{ }y′^{(t′)}_{L}} as inputs and outputs a detection result for the sub-series D′_{t′} and the series data P′_{t′}. Because the series data P′_{t′} has been predicted from the observed amount y′_{t′} and the sub-series D′_{t′} corresponds to the series data P′_{t′}, the detection result for the sub-series D′_{t′} and the series data P′_{t′} can be said to be a detection result for the observed amount y′_{t′}.

The error vector calculation unit 310 takes the T₂-L sub-series D′_{t′}={y′_{t′+1}, . . . , y_{t′+L}} and the T₂-L pieces of series data P_{t′}={\hat{ }y′^{(t′)}₁, . . . , \hat{ }y′^{(t′)}_{L}} as inputs, calculates errors of between elements of the sub-series D′_{t′}={y′_{t′+1}, . . . , y_{t′+L}} and elements of the predicted series data P_{t′}={\hat{ }y′^{(t′)}₁, . . . , \hat{ }y′^{(t′)}_{L}} (S310-B), and outputs an error vector e′ₜ=[e′_{(t′)}¹ . . . e′^{(t′)}_{L}]^{T}. Here, e′^{(t′)}ᵢ=y′_{t′+i}−\hat{ }y′^{(t′)}ᵢ where i=1, . . . , L.

The detection unit 330 receives the mean p and the variance-covariance matrix S prior to the abnormality detection.

The detection unit 330 takes the T₂-L error vectors eₜ=[e′^{(t′)}₁ . . . e′^{(t′)}_{L}]^{T} as inputs and calculates the following degree of abnormality Lt′ for each time t′=1, . . . . T₂-L using the mean μ, the variance-covariance matrix S, and the error vectors e′_{t′} (S330-1).

L_{t′}=logdet(S)+(e′_{t′}−μ)^{T}S⁻¹(e′_{t′}−μ)^{T}

This degree of abnormality L^{t′} is a quantity proportional to the negative log-likelihood when the error vectors have been fitted into a normal distribution.

Next, the detection unit 330 determines whether or not there is an abnormality based on which of a value corresponding to the degree of abnormality L_{t′} and a threshold value p is large or small to detect the abnormality (S330-2) and outputs the detection result. For example, the detection unit 330 determines that there is abnormality when the degree of abnormality satisfies L_{t′}>p and determines that there is no abnormality when the degree of abnormality satisfies L_{t′}≤p. The threshold value p is appropriately determined in advance by experiments, simulations, or the like.

The above configuration allows the present invention to be applied to abnormality detection.

### Third Embodiment

Parts different from the first embodiment will be mainly described.

In the first embodiment, the case has been discussed where the inverse function exists for a function that outputs a prediction of an observed amount (a predicted value \hat{ }y_{τ}^{(t)} from a state xₜ. However, for example, when the number of dimensions of the state xₜ is smaller than that of the prediction of the observed amount (the predicted value \hat{ }y_{τ}^{(t)}), it is not clear whether there is an inverse function that estimates the state xₜ from the observed amount yₜ.

In addition, when the number of dimensions of the observed amount yₜ is smaller than that of the basis function value zₜ, the problem of determining the basis function value zₜ from the observed amount yₜ is an underdetermined problem and it is necessary to introduce a regularization term appropriately.

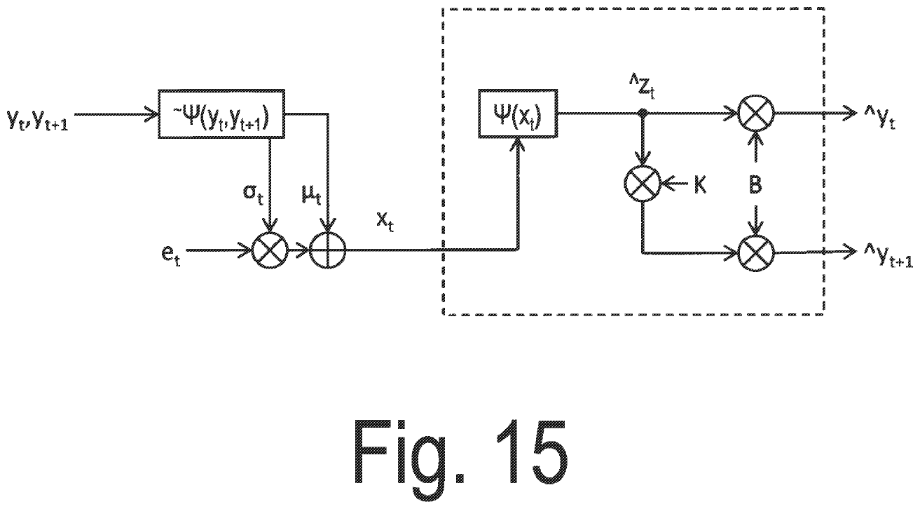

Therefore, in the present embodiment, the state is estimated from the observed amount by considering a generative model without considering the inverse function. FIG. 15 illustrates the proposed model. The right side (a dashed line part) of FIG. 15 illustrates an extended dynamic mode decomposition (EDMD) part which is a numerical calculation method for Koopman mode decomposition.

First, mean and variance parameters are estimated from observed amounts yₜ and yₜ₊₁ using a neural network ((αₜ, μₜ)←˜Ψ(yₜ, yₜ₊₁)). This process corresponds to encoding of a variational autoencoder and a part that performs this process is called an encoder.

Next, a latent variable (state xₜ) is sampled from a multivariate normal distribution according to the obtained values of the estimated mean and variance parameters μₜ and σₜ. Here, eₜ in FIG. 15 is a random number obtained from a normal distribution with mean 0 and variance 1.

Subsequent processing is similar to that of the first embodiment. An outline will be described below.

(3) Estimation of a reconstructed basis function value (to obtain an estimated value \hat{ }zₜ←Ψ(xₜ)), (4) prediction of a basis function (to obtain a predicted value \hat{ }z_{τ}^{(t)}=K^{τ}\hat{ }zₜ), and (5) prediction of an observed amount (to obtain a predicted value \hat{ }y_{τ}^{(t)}=B\hat{ }z_{τ}^{(t)})) are performed to output the estimated value xₜ and series data of predicted values {y_{τ}^{(t)}}. The process of obtaining a predicted value \hat{ }y_{τ}^{(t)} of the observed amount from the state xₜ corresponds to decoding of the variational autoencoder and a part that performs this process is called a decoder.

A general variational autoencoder learns the weight parameter θ of the neural network to minimize the following objective function.

$$[ Math . 12 ]$$

$$L ( θ ) = {{\sum }^{T}}_{τ = 0} ( {‖ {y}_{t + τ} - {Ψ}_{θ} ( {x}_{t + τ} ) ‖}^{2} + KL [ N ( {μ}_{θ} ( {y}_{t + τ} ) , {\sum }_{θ} ( {y}_{t + τ} ) \vert N ( 0 , l ) ) ] )$$

Here, KL[A|B] represents the Kullback-Leibler divergence of distributions A and B, N(μ, σ) represents a distribution of mean μ and variance σ, and μ_{θ}(yₜ) and Σ_{θ}(yₜ) are mean and variance parameters that are estimated by giving an observed amount y_{t+τ} to the neural network of weight parameter θ, respectively.

On the other hand, in the variational autoencoder of the present embodiment, the expansion coefficient B and the parameter K are also learned and optimized simultaneously with the weight parameter θ. That is, the following is minimized.

$$[ Math . 13 ]$$

$$L ( B , K , θ ) = E [ {{\sum }^{T}}_{τ = 0} ( {‖ {y}_{t + τ} - {\hat{y}}_{τ}^{( t )} ‖}^{2} + KL [ N ( {μ}_{θ} ( {y}_{t} , {y}_{t + 1} ) , {\sum }_{θ} ( {y}_{t} , {y}_{t + 1} ) ) \vert N ( 0 , l ) ] ]$$

Here, \hat{ }y_{τ}^{(t)}=BK^{τ}\hat{ }zₜ, and μ_{θ}(y_{t+τ}, y_{t+τ+1}) and Σ₇₄(y_{t+τ}, y_{t+τ+1}) represent mean and variance parameters that are estimated by giving observed amounts y_{t+τ} and y_{t+τ+1} to the neural network of the weight parameter θ, respectively. The difference between the first embodiment and the present embodiment includes the following two points.

The first embodiment assumes an inverse function, whereas the present embodiment assumes a probabilistic generative model.

The first embodiment minimizes the reconstruction error as an objective function, whereas the present embodiment adds a Kullback-Leibler divergence term for measuring the closeness of distributions to the reconstruction error.

Hereinafter, an estimation system that achieves the present embodiment will be described.

The estimation system according to the present embodiment includes a learning apparatus 100 and an estimation apparatus 200 (see FIG. 3).

The learning apparatus 100 executes the learning stage and the estimation apparatus 200 executes the estimation stage. First, the learning stage will be described.

Learning Stage

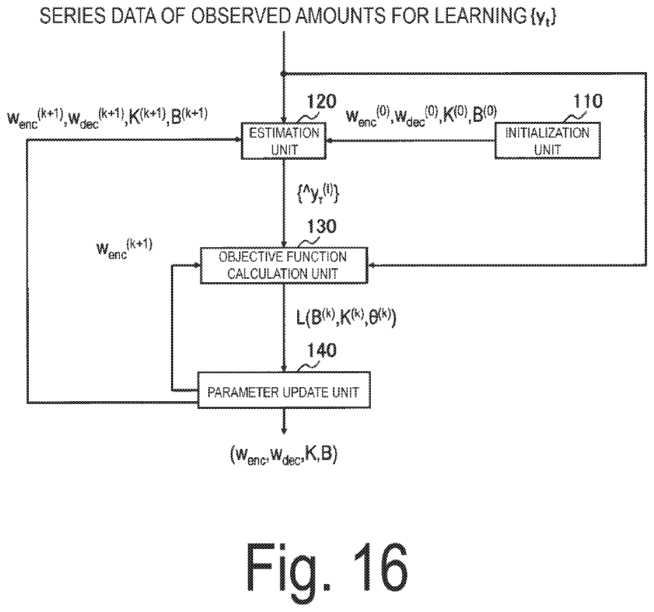

FIG. 16 illustrates a functional block diagram of the learning apparatus 100 and FIG. 5 is a flowchart of an example of its processing. The learning apparatus 100 includes an initialization unit 110, an estimation unit 120, an objective function calculation unit 130, and a parameter update unit 140.

The learning apparatus 100 takes series data {yₜ} of observed amounts for learning as an input and outputs parameters (w_{enc}, w_{dec}, K, B) which are learning results. w_{enc} represents a parameter used in the encoder, w_{dec} represents a parameter used in the decoder (a parameter of the basis function Ψ), K represents a parameter representing the time evolution, and B represents the expansion coefficient.

The learning stage is performed as follows.

Processing performed by the initialization unit 110 and the parameter update unit 140 is similar to that of the first embodiment and thus the description thereof will be omitted. However, the parameter update unit 140 receives the objective function L(B^{(k)}, K^{(k)}, θ^{(k)}) instead of the objective function J(Θ^{(k)}) to perform processing.

Estimation Unit 120

The estimation unit 120 takes the series data {yₜ} of observed amounts for learning and the initialized or updated parameters w_{enc}^{(k)}, w_{dec}^{(k)}, K^{(k)}, and B^{(k)} as inputs to perform (1) estimation of mean and variance parameters of a state (to obtain estimated values at and μₜ), (2) estimation of the state (to obtain an estimated value xₜ), (3) estimation of a reconstructed basis function value (to obtain an estimated value \hat{ }zₜ), (4) prediction of a basis function (to obtain a predicted value \hat{ }z_{τ}^{(t)}, and (5) prediction of an observed amount (to obtain a predicted value \hat{ }y_{τ}^{(t)}) (S120) and outputs the predicted value \hat{ }y_{τ}^{(t)}. (1) and (2) will be described because (3) to (5) are similar to those of the first embodiment.

(1) First, the estimation unit 120 estimates mean and variance parameters of the state from series data {yₜ} of observed amounts for learning and the current parameter w_{enc}^{(k)} by using the neural network. That is, (σₜ, μₜ)=˜Ψ(yₜ: w_{enc}^{(k)}). In the present embodiment, the input may be two or more observed amounts yₜ for learning because the neural network is used. For example, the mean and vanance parameters of the state may be estimated from the two observed amounts yₜ and yₜ₊₁ for learning such that (σₜ, μₜ)=˜Ψ(yₜ, yₜ₊₁; w_{enc}^{(k)}). It is conceivable that estimating the mean and variance parameters of the state using two or more observed amounts for learning in this way makes it easier to identify the features of the state.

(2) Next, the state xₜ is sampled from a multivariate normal distribution according to (αₜ, μₜ).

Objective Function Calculation Unit 130

The objective function calculation unit 130 takes the series data {y_{t+τ}} of observed amounts for learning, the series data of predicted values {\hat{ }y_{τ}^{(t)}}, and the parameter w_{enc}^{(k)} as inputs to calculate a value of the objective function L(B^{(k)}, K^{(k)}, θ^{(k)}) (S130) and outputs the calculated value L(B^{(k)}, K^{(k)}, θ₍ₖ₎). Here, θ^{(k)} is a set of parameters w_{enc}^{(k)} and w_{dec}^{(k)}.

$$[ Math . 14 ]$$

$$L ( B , K , θ ) = E [ c {{\sum }^{T}}_{τ = 0} ( {‖ {y}_{t + τ} - {\hat{y}}_{τ}^{( t )} ‖}^{2} + dKL [ N ( {μ}_{θ} ( {y}_{t} , {y}_{t + 1} ) , {\sum }_{θ} ( {y}_{t} , {y}_{t + 1} ) ) \vert N ( 0 , l ) ] ]$$

Here, \hat{ }y_{τ}^{(t)}=B^{(k)}K^{(k)τ}\hat{ }zₜ. At least two or more time-series observed amounts yₜ and y_{τ+1} are required in order to update K^{(k)} at the same time, and T is any integer of 1 or more. c and d are parameters for determining how much importance is placed on the terms and are appropriately set using experimental results and simulation results.

Estimation Stage

FIG. 7 illustrates a functional block diagram of the estimation apparatus 200 and FIG. 8 is a flowchart of an example of its processing. The estimation apparatus 200 includes an estimation unit 220.

The estimation apparatus 200 sets the parameters (w_{enc}, w_{dec}, K, B) received from the learning apparatus 100 in the estimation unit 220 prior to the estimation and prediction.

Estimate State from Observed Amount and Predict Observed Amount

When estimating a state from an observed amount and predicting observed amounts (in the case of the algorithm 2 of the first embodiment), the estimation apparatus 200 takes an observed amount yₜ as an input, estimates a state corresponding to the observed amount yₜ, predicts series data of observed amounts subsequent to yₜ, and outputs the estimated value xₜ and the predicted series data {\hat{ }y_{τ}^{(t)}}. For example, the estimation apparatus 200 may take series data yₜ, yₜ₊₁, . . . , and y_{t+N} of observed amounts as an input and output series data xₜ, xₜ₊₁, . . . , x_{t+N} of estimated values and N pieces of predicted series data {\hat{ }y_{τ}^{(t)}}, {\hat{ }y_{τ}^{t+1})}, . . . , {\hat{ }y_{τ}^{(t+N)}}.

Estimation Unit 220

The estimation unit 220 takes an observed amount yₜ as an input and performs predetermined processes on the observed amount yₜ to estimate a state (S220). In the present embodiment, the predetermined processes are estimation of mean and variance parameters of a state (to obtain estimated values at and μₜ) and (2) estimation of the state (to obtain an estimated value xₜ). Further, the estimation unit 220 performs (3) estimation of a reconstructed basis function value (to obtain an estimated value \hat{ }zₜ), (4) prediction of a basis function (to obtain a predicted value \hat{ }z_{τ}^{(t)}), and (5) prediction of observed amounts (to obtain predicted values \hat{ }y_{τ}^{(t)}) (S220), and outputs the estimated value xₜ and series data of predicted values {\hat{ }y_{τ}^{(t)}}. (1) and (2) will be described because (3) to (5) are similar to those of the first embodiment.

(1) First, the estimation unit 220 estimates mean and variance parameters of the state from the observed amount yₜ and the parameter w_{enc} by using the neural network. That is, (σₜ, μₜ)=˜Ψ(yₜ; w_{enc}). In the present embodiment, the input may be two or more observed amounts yₜ and a number of observed amounts yₜ corresponding to the neural network learned by the learning apparatus 100 are taken as inputs.

(2) Next, the state xₜ is sampled from a multivariate normal distribution according to (σₜ, μₜ).

Predict Observed Amount from Observed Amount

The prediction of an observed amount from an observed amount (in the case of the algorithm 3 of the first embodiment) is similar to that of the first embodiment.

Advantages

The same advantages as those of the first embodiment can be achieved. By considering the generative model, the state is estimated without considering the inverse function. Here, the present embodiment may be combined with a modification of the first embodiment or the second embodiment.

Others

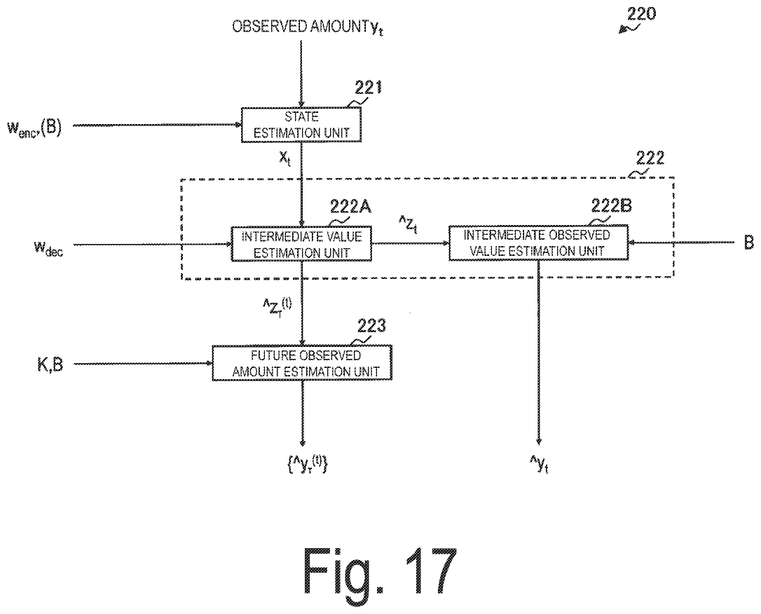

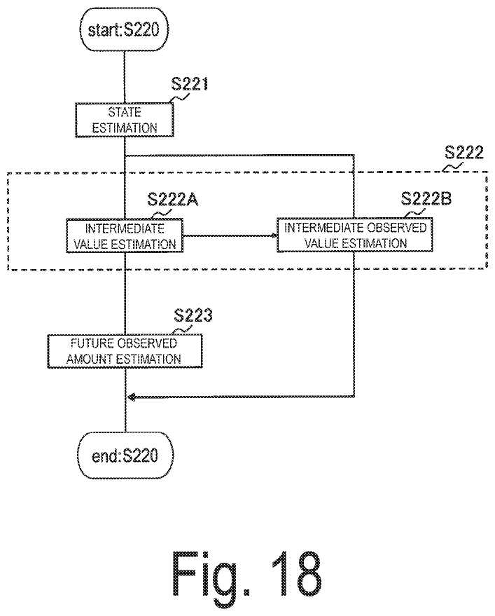

The estimation unit 220 of each of the first and third embodiments can also be represented by a functional block diagram of FIG. 17. FIG. 18 is an flowchart of an example of the processing of the estimation unit 220.

The estimation unit 220 includes a state estimation unit 221, an observed amount estimation unit 222, and a future observed amount estimation unit 223. Further, the observed amount estimation unit 222 includes an intermediate value estimation unit 222A and an intermediate observed value estimation unit 222B. Processing performed by the state estimation unit 221 differs between the first and third embodiments. Processing performed by the observed amount estimation unit 222 and the future observed amount estimation unit 223 is the same between the first and third embodiments.

State Estimation Unit 221

The state estimation unit 221 estimates a state from an observed amount using the encoder of the autoencoder (S221) and outputs the estimated state.

In the first embodiment, the state estimation unit 221 receives the parameter w_{enc} of the neural network and the expansion coefficient B prior to the estimation process. The state estimation unit 221 takes an observed amount yₜ as an input and estimates a basis function value zₜ using the expansion coefficient B. That is, zₜ=B⁺(yₜ). Furthermore, the state estimation unit 221 estimates the state such that xₜ=Φ⁻¹ (zₜ: w_{enc}) using the neural network of Expression (9).

In the third embodiment, the state estimation unit 221 receives the parameter wen of the neural network prior to the estimation process. The state estimation unit 221 takes one or more observed amounts yₜ as inputs and estimates mean and vanance parameters of a state from the one or more observed amounts yₜ and the parameter w_{enc} using the neural network. For example, the state estimation unit 221 estimates mean and variance parameters of a state from two observed amounts yₜ and yₜ₊₁ such that (σₜ, μₜ)=˜Ψ(yₜ, yₜ₊₁; w_{enc}). Next, the state estimation unit 221 estimates the state xₜ by sampling from a multivariate normal distribution according to (σt, μₜ).

Observed Amount Estimation Unit 222

The observed amount estimation unit 222 estimates an observed amount from the state using the decoder of the autoencoder (S222) and outputs the estimated observed amount.

In the case of the first embodiment, processing performed by the state estimation unit 221 is defined by a first function, processing performed by the observed amount estimation unit 222 is defined by a second function, and the first function is the inverse function of the second function.

Intermediate Value Estimation Unit 222A

The intermediate value estimation unit 222A receives the parameter w_{dec} of the neural network prior to the estimation process.

The intermediate value estimation unit 222A takes the state xₜ as an input, estimates a reconstructed basis function value using the neural network of Expression (9) such that \hat{ }zₜ=Φ(xₜ; w_{dec}) (S222A), and outputs the estimated value \hat{ }zₜ. Here, the estimated value of the reconstructed basis function value will also be referred to as an intermediate value.

Intermediate Observed Value Estimation Unit 222B

The intermediate observed value estimation unit 222B receives the expansion coefficient B prior to the estimation process.

The intermediate observed value estimation unit 222B takes the estimated value \hat{ }zₜ as an input, estimates an observed value from the estimated value \hat{ }zₜ (S222B), and outputs the estimated value \hat{ }yₜ. This corresponds to τ=0 in the following equations.

\hat{ }z_{τ}^{(t)}=K^{τ}\hat{ }zₜ

\hat{ }yτ^{(t)=B\hat{ }z}_{τ}^{(t)}

That is, \hat{ }yₜ=B\hat{ }zₜ.

Future Observed Amount Estimation Unit 223

The future observed amount estimation unit 223 receives K and B prior to the estimation process.

The future observed amount estimation unit 223 estimates a future observed amount, which is a value to which the observed amount changes with time, using the parameter K representing the time evolution (S223) and outputs the estimated future observed amount.

First, the future observed amount estimation unit 223 obtains a future intermediate value \hat{ }z_{τ}^{(t)}, which is a value to which the estimated value \hat{ }zₜ changes with time, using the parameter K.

That is, \hat{ }z_{τ}^{(t)}=K^{τ}\hat{ }zₜ. Here, τ=1, . . . , T.

Further, the future observed amount estimation unit 223 estimates a future observed amount \hat{ }y_{τ}^{(t)} from the future intermediate value \hat{ }z_{τ}^{(t)} using the expansion coefficient B. That is, \hat{ }y_{τ}^{(t)}=B\hat{ }z_{τ}^{(t)}.

The estimation unit 120 of the learning apparatus of each of the first and third embodiments can be expressed in the same manner as described above. However, processing is performed using observed amounts for learning and parameters to be learned.

Hardware Configuration

Each of the learning apparatus and the estimation apparatus is, for example, a special apparatus formed by loading a special program into a known or dedicated computer having a central processing unit (CPU), a main storage device (a random access memory (RAM)), and the like. Each of the learning apparatus and the estimation apparatus executes, for example, each process under the control of the CPU. Data input to each of the learning apparatus and the estimation apparatus and data obtained through each process are stored, for example, in the main storage device, and the data stored in the main storage device is read out to the central processing unit as needed and used for other processing. Each processing unit of the learning apparatus and the estimation apparatus may be at least partially configured by hardware such as an integrated circuit. Each storage unit included in the learning apparatus and the estimation apparatus can be configured, for example, by a main storage device such as a random access memory (RAM) or by middleware such as a relational database or a key-value store. However, each storage unit does not necessarily have to be provided inside the learning apparatus and the estimation apparatus and may be configured by a hard disk, an optical disc, or an auxiliary storage device formed from a semiconductor memory device such as a flash memory and may be provided outside the learning apparatus and the estimation apparatus.

Other Modifications

The present invention is not limited to the above embodiments and modifications. For example, the various processes described above may be executed not only in chronological order as described but also in parallel or on an individual basis as necessary or depending on the processing capabilities of the apparatuses that execute the processing. In addition, appropriate changes can be made without departing from the spirit of the present invention.

Program and Recording Medium

The various processing functions of each device (or apparatus) described in the above embodiments and modifications may be implemented by a computer. In this case, the processing details of the functions that each device may have are described in a program. When the program is executed by a computer, the various processing functions of the device are implemented on the computer.

The program in which the processing details are described can be recorded on a computer-readable recording medium. The computer-readable recording medium can be any type of medium such as a magnetic recording device, an optical disc, a magneto-optical recording medium, or a semiconductor memory.

The program is distributed, for example, by selling, giving, or lending a portable recording medium such as a DVD or a CD-ROM with the program recorded on it. The program may also be distributed by storing the program in a storage device of a server computer and transmitting the program from the server computer to another computer through a network.

For example, a computer configured to execute such a program first stores, in its storage unit, the program recorded on the portable recording medium or the program transmitted from the server computer. Then, the computer reads the program stored in its storage unit and executes processing in accordance with the read program. In a different embodiment of the program, the computer may read the program directly from the portable recording medium and execute processing in accordance with the read program. The computer may also sequentially execute processing in accordance with the program transmitted from the server computer each time the program is received from the server computer. In another configuration, the processing may be executed through a so-called application service provider (ASP) service in which functions of the processing are implemented just by issuing an instruction to execute the program and obtaining results without transmission of the program from the server computer to the computer. The program includes information that is provided for use in processing by a computer and is equivalent to the program (such as data having properties defining the processing executed by the computer rather than direct commands to the computer).

In this mode, the device is described as being configured by executing the predetermined program on the computer, but at least a part of the processing may be implemented in hardware.

1. An estimation apparatus comprising:
a state estimation unit configured to estimate a state from an observed amount using an encoder,
an observed amount estimation unit configured to estimate an observed amount from a state using the decoder, and
a future observed amount estimation unit configured to estimate a future observed amount using a parameter K representing time evolution, the future observed amount being a value to which the observed amount changes with time,
wherein a parameter of the encoder, a parameter of the decoder, and the parameter K are optimized simultaneously.

2. The estimation apparatus according to claim 1,
wherein processing performed by the state estimation unit is defined by a first function, processing performed by the observed amount estimation unit is defined by a second function, and the first function is an inverse function of the second function.

3. The estimation apparatus according to claim 1,
wherein the parameter of the encoder, the parameter of the decoder, and the parameter K are optimized by a variational autoencoder that uses the state estimation unit as an encoder and the observed amount estimation unit as a decoder, and
the observed amount is a time series observed amount.

4. The estimation apparatus according to claim 1,
wherein the observed amount estimation unit includes:
an intermediate value estimation unit configured to estimate an intermediate value from the state; and
an intermediate observed value estimation unit configured to estimate the observed value from the estimated intermediate value, and
the future observed amount estimation unit is configured to estimate the future observed amount from a future intermediate value, the future intermediate value being a value to which the intermediate value changes with time and being obtained using the parameter K.

5. A learning apparatus configured to learn parameters used in the estimation apparatus according to claim 2,
wherein the second function uses a parameter of a basis function, the parameter of the basis function being the parameter of the decoder of the autoencoder,
the first function uses a parameter of an inverse function of the basis function, the parameter of the inverse function of the basis function being the parameter of the encoder of the autoencoder,
the learning apparatus comprises:
an estimation unit configured to perform, using series data of an observed amount for learning, the parameter of the basis function, the parameter of the inverse function, the parameter K, and an expansion coefficient, (1) estimation of a value of the basis function, (2) estimation of a state, (3) estimation of a value of a reconstructed basis function, (4) prediction of the basis function, and (5) prediction of the observed amount;
an objective function calculation unit configured to obtain, using the series data of the observed amount for learning, series data of an estimated value of the basis function, series data of an estimated value of the state, series data of an estimated value of the reconstructed basis function, series data of a predicted value of the basis function, and series data of a predicted value of the observed amount, (i) a prediction error of the observed amount, (ii) a prediction error of the basis function, (iii) a regularization term for weights of a neural network based on the parameter of the basis function and the parameter of the inverse function, and (iv) a structure of the state, and obtain a value of an objective function from the obtained values; and
an update unit configured to update the parameter of the basis function, the parameter of the inverse function, the parameter K, and the expansion coefficient based on the objective function,
the state changes non-linearly with time, and
the observed amount is obtainable by performing an observation process of changing non-linearly with time as the state changes with time.

6. An estimation method comprising:
estimating a state from an observed amount using an encoder;
estimating an observed amount from a state using the decoder; and
estimating a future observed amount using a parameter K representing time evolution, the future observed amount being a value to which the observed amount changes with time,
wherein a parameter of the encoder, a parameter of the decoder, and the parameter K are optimized simultaneously.

7. A program for causing a computer to operate as the estimation apparatus according to claim 1.

8. A program for causing a computer to operate as the estimation apparatus according to claim 2.

9. A program for causing a computer to operate as the estimation apparatus according to claim 3.

10. A program for causing a computer to operate as the estimation apparatus according to claim 4.

11. A program for causing a computer to operate as the learning apparatus according to claim 5.
